(19) United States
(12) Patent Application Publication
(10) Pub. No.: US 2024/0215505 A1
(43) Pub. Date: Jul. 4, 2024

(54) MODULAR PLANT PLUG INSERTS

(71) Applicant: Local Bounti Operating Company, LLC, Hamilton, MT (US)

(72) Inventors: Ryan SWEENEY, Hamilton, MT (US); Ari HOROWITZ, Brooklyn, NY (US); Jessica STAHA, Hamilton, MT (US); Seth SWANSON, Missoula, MT (US)

(73) Assignee: Local Bounti Operating Company, LLC, Hamilton, MT (US)

(21) Appl. No.: 18/399,815

(22) Filed: Dec. 29, 2023

Related U.S. Application Data
(60) Provisional application No. 63/477,917, filed on Dec. 30, 2022.

(51) Int. Cl. A01G 31/02

(52) U.S. Cl. CPC A01G 31/02

(57) ABSTRACT

A gutter system for growing one or more plants may be provided. The gutter system may include a gutter and one or more inserts. The gutter may have a trough, a first side wall extending upward from the trough, and a second side wall opposite the first side wall and extending upward from the trough. The gutter inserts may each have an outer wall, a clip connected to the outer wall, such that the clip secures the gutter insert to the gutter, and an inner wall which slopes away from the outer wall. The gutter insert may be hollow and the first gutter insert may be connected to the first side wall and the second gutter insert may be connected to the second side wall.

### FIELD

An exemplary embodiment relates to the field of controlled environment agriculture.

### BACKGROUND

Controlled environment agriculture (CEA) is an emerging form of aeroponically or hydroponically based agriculture where crop growth is optimized within a controlled environment. This allows crops to be grown year-round in locations that they otherwise could not survive or thrive in. Some CEA systems may implement a gutter system which includes long, shallow troughs filled with a nutrient-rich solution. Crops may be placed in pots or cups and placed in the troughs, where their roots can access the nutrient solution. Gutters can be used to grow a wide variety of plants, including leafy greens, herbs, tomatoes, and more. They can be highly efficient, allowing the plants to absorb nutrients directly from the water.

A major challenge facing CEA is the use of space. In particular, it is desirable to maximize the use of space within a CEA facility in order to maximize the number of plants harvested. However, the use of space needs to be balanced to allow the crops enough room to grow such that their leaves can receive light. Various planting arrangements and patterns can be used to increase planting density when initially seeding crops, such as wide-row planting, for example. However, initial planting arrangements such as wide row planting still wastes large amounts of space and are not dynamic enough to meet plant needs that are identified during growth. Gutters used in CEA systems may also have some limitations. For example, gutters may be prone to algae growth and other forms of contamination.

### SUMMARY

According to at least one exemplary embodiment, a gutter system with modular plant plug inserts may be shown and described. An exemplary embodiment of a gutter insert may include a wall or multiple walls to hold a plantlet or seedling in place via friction. The walls may be on an inside of the insert and may be inclined or angled to hold the plants with a greater friction force via gravity. An outside portion of an exemplary insert may include a clip sized to fit over the walls of the gutter. For example, the clip may be sized according to the thickness of the gutter wall. Additionally, the clip may include a notch configured to receive a protrusion on the top end of the gutter wall in order to securely fasten the inserts to the wall. The clip may be attached to the gutter such that the plantlet or seedling is raised slightly above the bottom surface of the gutter. This may advantageously leave an air gap between the plant plug and the nutrient-water solution, further promoting root growth.

The inserts may be attached to the gutter such that their height and location are fixed. However, an exemplary embodiment may also allow the plant plugs to be slid across the gutter, while still maintaining the height and a centered position within the gutter. This can allow an exemplary embodiment to adjust density along an axis parallel to the gutter.

An exemplary insert may include walls above and below the plant plug. The walls may protect the plant from infections or pests. Additionally, the walls may shield the water in the gutter from light and algae growth. The walls around the plant plug may protect the roots growing within the air gap from air pruning and may maintain a microclimate within the gutter below the plant plugs and inserts.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a gutter with an exemplary insert fixed thereto.

FIG. 2 is an exemplary embodiment of two gutters with inserts fixed thereto.

FIG. 3 is an exemplary embodiment of a gutter with an integrally formed plant insert.

FIG. 4 is an exemplary embodiment of a gutter with an exemplary insert.

FIG. 5A is an exemplary embodiment of a gutter with an exemplary insert.

FIG. 5B is an exemplary embodiment of a gutter with an exemplary insert.

FIG. 5C is an exemplary embodiment of a gutter with an exemplary insert.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

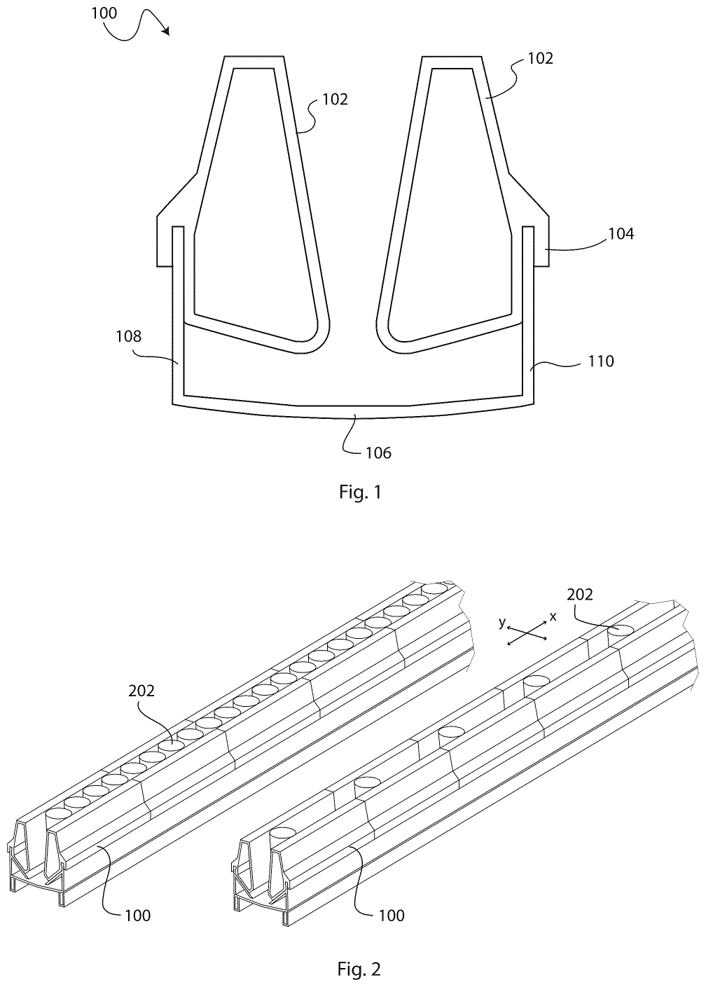

An exemplary embodiment may provide an insert for holding crops, plantlets, or seedlings. Referring to the exemplary embodiment illustrated in FIG. 1, an embodiment may include one or more inserts 100 that may be attached to a gutter, which may have a gutter trough 106, a first side wall 108, and a second side wall 110. The inserts 100 and gutter may be made of, for example, metal, plastic, PVC, rubber or any other material known in the art. In some embodiments the inserts 100 may be made of the same material as the gutter, in other embodiment they may be made of different material, for example the gutter may be metal while the inserts 100 are PVC. The inserts 100 may provide outer walls 102 for holding the crop or plant substrate via friction. In an exemplary embodiments the outer wall 102 may further have a plurality of teeth, which may be sized according to the crop or plant substrate and may allow for a tighter hold on the crop or plant substrate. In some embodiments the teeth may be smooth, and in other embodiments the teeth may have a sharp edge. The outer walls of the insert 102 may be sized according to the crop varietal and the gutter size. For example, some varietals may require more space than others at different stages of growth, and the angle and sizing of the walls can be configured to accommodate this growth. In an exemplary embodiment, the outer walls 102 may be angled in order to hold the plantlet or plant plug in place. Further, a bottom and surrounding portion of the walls may contact the walls of the gutter such that additional friction is created between the bottom portion of the outer walls 102 of the insert and the walls 108-110 of the gutter. An exemplary insert 100 may be double-walled in order to provide further support.

An exemplary insert 100 may leave an open air gap 112 below the plant plug and above the bottom of the gutter trough 106. In some embodiments the open air gap 112 may allow roots to pass through to, for example, a nutrient-rich water solution in the gutter. Leaving a gap between the plant plug and the nutrient-water solution can further expedite root growth, and longer roots may allow a crop to absorb additional nutrients thus expediting overall plant growth. The air gap 112 may be protected by the insert 100 and the gutter to prevent air pruning of the roots. A microclimate may be controlled within the air gap 112, for example, to increase humidity within the air gap 112 above a level outside the air gap 112.

The inserts 100 may be modular. It may be contemplated that a gutter can contain multiple different inserts of differing sizes. Further, inserts may be sized according to the specific application or intended plant varietal. The modularity of the inserts may allow for crops of varying sizes and shapes to fit within a single gutter. In some embodiments, a crop may be transplanted to an insert with a different size or shape (such as a larger or smaller root air gap or a thicker or thinner plant plug).

An exemplary insert 100 may be secured to the walls 108-110 of the gutter. For example, an embodiment may include clips 104 which engage the walls 108-110 of the gutter. The clips 104 may be sized according to the thickness of the walls 108-110 of the gutters. The clips 104 may be made of the same material as the rest of the insert 100, and may be attached to or may be of a single piece with the rest of the insert 100. In an exemplary embodiment, the clips 104 may be adjustable such that the height of the insert 100 can be moved with regards to the gutter. For example, the clip 104 may be adjusted to receive more or less of the sidewalls 108-110 of the gutter in order to lower or raise the plant plug above the surface of the gutter trough 106 and nutrient-water solution. Differently sized or placed clips can adjust the size and height of the air gap 112. In some embodiments the clips 104 may further be made of a material that helps to grip the walls 108-110 of the gutter, and/or may be treated with an adhesive or other material to increase stability.

FIG. 2 may illustrate an exemplary plant gutter carrying multiple inserts 100 which can each carry one or more plants, seedlings, or plantlets. As shown in FIG. 2, planted crops 202 may be placed along the gutter according to an optimized spacing. The crops can be spread apart across the gutter or along the hypothetical “x-axis” running parallel to the gutter. Crops can also be spaced apart along the “y-axis” perpendicular to the gutter direction by separating the gutters and leaving space in between. By varying the density of the planted crops 202 and the gutters 106, variable plant growth needs may be met in a single facility.

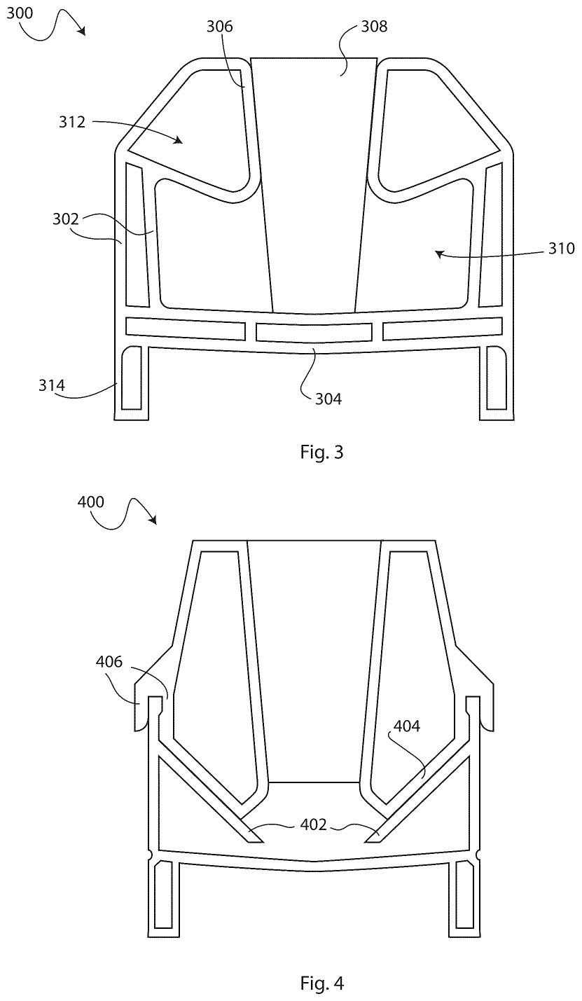

Referring now to the exemplary embodiment in FIG. 3, FIG. 3 may illustrate an exemplary integrated gutter 300. The integrated gutter 300 may include, for example, a double-walled sidewall 302 to provide structural integrity and for additional insulation. The double wall support on the sidewalls 302 and bottom portion 304 of the gutter 300 may reduce torsion while increasing rigidity and strength. In some embodiments the integrated gutter 300 may be made of a plurality of hollow pieces 312. In an exemplary embodiment the gutter may be formed through, for example, extrusion molding.

The sidewall 302 may rise and bend inwards towards the top portion to form a holding portion 306 in order to contact a plant plug 308. Similar to the inserts 100, the plant plug 308 may be held by the holding portion 306 via friction, so that there is an airgap between the bottom of the plant plug 308 and the bottom portion 304 of the gutter 300. In some embodiments the holding portion 306 may further have a plurality of teeth which may increase the holding strength on the plant plug 308. In some embodiments the teeth may be smooth, while in others the teeth may be sharp, depending on, for example the type of gutter insert and/or plant being held. Alternatively, the plant plug in the integrated gutter 300 may rest on the surface of the bottom of the gutter 304. The integrated gutter 300 may further have an inner trough 310, through which water or nutrients may be dispensed. The integrated gutter 300 may further have one or more legs 314, which may allow the gutter to stand freely on the ground or another surface.

Referring now to the exemplary embodiment in FIG. 4, FIG. 4 may illustrate an alternate embodiment of a gutter and insert. In this exemplary embodiment, the gutter may include an angled interior wall surface 402. The angled interior wall surface 402 of the gutter may provide an additional contact point to create additional friction between the insert and the gutter, thus further securing the insert. For example, the insert may include a bottom wall portion 404 which is at the same or similar angle as the interior wall surface 402, such that the bottom wall portion 404 of the insert sits flat on the angled interior wall surface 402. This can help prevent sagging or other defects in the inserts by supporting the insert. The interior walls 402 may also protect the water solution in the gutter from algae growth caused by light or other contaminants.

Still referring to the embodiment illustrated in FIG. 4, an exemplary clip may include a notch 406. The notch 406 may be sized to receive a corresponding protrusion on the gutter wall. For example, the notch 406 may secure the position of the insert on the gutter wall.

In an exemplary embodiment plant plugs may be transplanted autonomously via, for example, robotics, into one or more of the gutter or gutter inserts described above. In an exemplary embodiment, robotics may grasp onto the inserts in order to lift a crop out of the gutter. The insert may be transplanted into another gutter section, or the plant may be transplanted from the insert into another growing area or into a harvesting receptacle. Alternatively, it may be contemplated that the insert facilitates movement of robotics to guide them around the plant or plant plug, thus facilitating the transplant of crops from the insert into a subsequent phase, location, or harvesting receptacle. In yet another alternative embodiment, the crops may be harvested by moving the plants along the gutter (x-axis) towards one end of the gutter, where they may be received by a receptacle or by a form of robotics for transplanting. Crops may be lifted out of the gutters manually or a mechanical robotic mechanism may be implemented to life the crops out of the gutters.

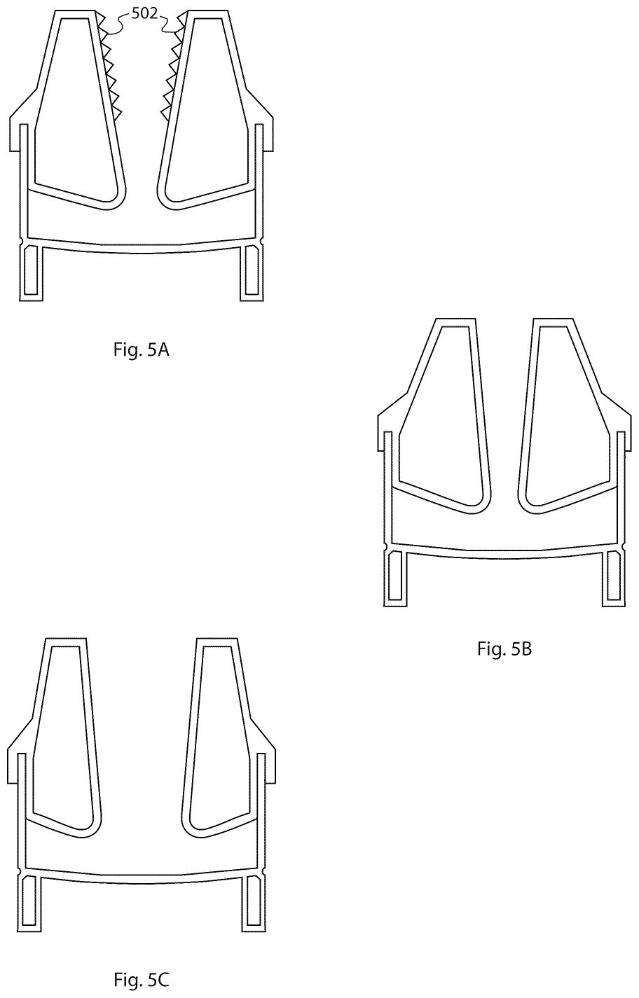

As shown in the examples in FIGS. 5A-5C, an exemplary embodiment may include inserts of many different shapes and/or sizes. For example, the insert in FIG. 5A may include a choke point at the bottom of the insert walls which converge on one another in order to hold or constrict the plantlet. Alternatively, FIG. 5B may illustrate an exemplary embodiment where the insert walls are brought closer together towards the top portion of the insert, for example, to accommodate a smaller plantlet. FIG. 5C may illustrate an exemplary embodiment where the insert walls are spaced farther apart from one another to accommodate a larger or more fully grown plant. The inserts may be designed or chosen based on the current application, such as a specific plant or contemplated trial. For example, the inserts may be designed in a three-dimensional modeling software and then may be produced via additive manufacturing or three-dimensional printing. Alternatively, the inserts may be shaped or extruded from a plastic material.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A gutter system for growing one or more plants, comprising:
a gutter further comprising;
a trough;
a first side wall extending upward from the trough; and
a second side wall opposite the first side wall and extending upward from the trough;
a first gutter insert and second gutter insert, each gutter insert further comprising;
an outer wall;
a clip connected to the outer wall, wherein the clip is configured to secure the gutter insert to the gutter; and
an inner wall which slopes away from the outer wall;
wherein the gutter insert is hollow
wherein the first gutter insert is connected to the first side wall and the second gutter insert is connected to the second side wall.

2. The gutter system of claim 1, wherein the slope of the inner wall of the first gutter insert and the second gutter insert is the same as the slope of a first set of one or more plant or crop substrates; and
wherein the gutter system holds the first set of one or more plant or crop substrates between the first gutter insert and the second gutter insert.

3. The gutter system of claim 2, wherein the one or more plant or crop substrates are held between the first gutter insert and the second gutter insert via friction.

4. The gutter system of claim 2, wherein inner wall further comprises at least a plurality of teeth configured to grip the one or more plant or crop substrates.

5. The gutter system of claim 2, wherein the bottom of the plant or crop substrate rests on the trough.

6. The gutter system of claim 2, wherein there is an air gap between the bottom of the plant or crop substrate and the trough.

7. The gutter system of claim 6, further comprising water and/or plant nutrients configured to run through the trough.

8. The gutter system of claim 7, wherein the depth of the water and/or plant nutrients running through the trough is at least enough to cover the bottom of the plant or crop substrates.

9. The gutter system of claim 1, wherein the gutter further comprises a first leg and a second leg extending downwards from the trough.

10. The gutter system of claim 1, wherein the gutter further comprises an angled interior surface that extends inwards and down from each of the first wall and the second wall; and
wherein each of the first gutter insert and second gutter insert further comprises a bottom wall portion which has a similar or same angle to that of the angled interior surface wall.

11. The gutter system of claim 2, wherein the outer wall and the inner wall of the gutter inserts are double walled with hollow interiors.

12. The gutter system of claim 2, wherein the gutter walls further comprise a protrusion;
the gutter insert clip further comprises a notch; and
the notch is configured to receive the protrusion such that the gutter insert is secured to the gutter wall.

13. The gutter system of claim 2, further comprising a third and fourth gutter insert;
wherein the third and fourth gutter insert have a slope the same as a second set of one or more plant or crop substrates;
wherein the third gutter insert is connected to the first wall and the second gutter insert is connected to the second wall.

14. The gutter system of claim 13, wherein the slop of the first set of one or more plant or crop substrates is different than the slope of the second set of one or more plant or crop substrates.

15. A gutter insert for growing one or more plants, comprising:
an outer wall;
a clip connected to the outer wall, wherein the clip is configured to secure the gutter insert to a gutter; and
an inner wall which slopes away from the outer wall;
wherein the gutter insert is hollow.

16. The gutter insert of claim 15, wherein the slope of the inner wall is the same as the slope of a plant or crop substrate.

17. The gutter insert of claim 15, wherein the inner wall further comprises at least a plurality of teeth configured to grip the plant or crop substrate.

18. The gutter insert of claim 16, wherein the outer wall and the inner wall are double walled with hollow interiors.
